(19) United States
(12) Patent Application Publication
(10) Pub. No.: US 2003/0099924 A1
(43) Pub. Date: May 29, 2003

(54) Learning support method and learning support system

(76) Inventors: Sougo Tsuboi, Kawasaki-shi (JP); Yasuko Nakayama, Yokohama-shi (JP); Masana Minami, Koganei-shi (JP); Naohiro Shirai, Hino-shi (JP); Kouichi Sasaki, Kawasaki-shi (JP); Mika Fukui, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/303,760

(22) Filed: Nov. 26, 2002

(30) Foreign Application Priority Data
Nov. 28, 2001 (JP) 2001-362924
Mar. 29, 2002 (JP) 2002-097655

(51) Int. Cl. G09B 3/00

(52) U.S. Cl. 434/350; 434/362; 434/236

(57) ABSTRACT

A learning support system detects an input operation by each user, whenever he operates his terminal apparatus, stores a learning history of each user whenever input operation is detected, learning history including input operation and first time period which is time period from starting time when he starts learning until when input operation is detected, to obtain set of learning histories corresponding to each user and being stored from starting time until when he finishes to learn learning material, retrieves, whenever predetermined time period elapses from starting time corresponding to first user, one learning history, to obtain retrieved learning history whose first time period is equal to second time period from starting time corresponding to first user until when predetermined time period elapses, from sets of learning histories corresponding to second user, and displays retrieved learning history on first user's terminal apparatus.

### CROSS-REFERENCE TO RELATED APPLICATIONS

This application is based upon and claims the benefit of priority from the prior Japanese Patent Applications No. 2001-362924, filed Nov. 28, 2001; and No. 2002-097655, filed Mar. 29, 2002, the entire contents of both of which are incorporated herein by reference.

### BACKGROUND OF THE INVENTION

1. Field of the Invention

The present invention relates to a learning support system which supports a learner who learns by himself/herself by using learning materials.

2. Description of the Related Art

Recently, with the spread use of inexpensive computers and the Internet, distance learning using computers (so-called e-Learning) has been widely used, which assists group learning by a teacher and a plurality of students in a class.

E-learning imposes no restrictions on learners with regard to time and place. A learner can therefore learn by himself/herself at any time (e.g., in the intervals of work, at midnight, or on holiday) in any place (e.g., in home or office) at his/her convenience. In addition, many self-learning materials for e-learning have been produced in correspondence courses designed for re-education for workers of middle or advanced age, lifelong education such as language education, at-home learning for truant children, and the like.

However, the learning style of distance learning is of a self-learning form, and hence it is difficult for a learner to continue learning. The main cause is that since the learner cannot see other learners, he/she feels a sense of isolation, easily becomes tired of learning, and loses motivation. In addition, it is difficult for distance learning to incorporate “competition”, which is a necessary factor to improve the willingness to learn. This also spurs the deterioration in motivation.

In order to eliminate the sense of isolation felt by a learner, in some e-learning systems, the learner is notified of the contact information of other learners who are studying the same learning materials and a distance learning site is provided, which has prepared a communication tool such as an electronic bulletin board to allow learners to communicate with each other. In general people try to know each other why they are mutually interested in their activities. The above communication tool is therefore effective for learners who have intentions to actively communicate with other learners, but not effective for learners who have no such intentions. In addition, no competition occurs unless the respective learners have opportunities to become interested in other learners.

As described above, the conventional learning support system cannot provide any effective solution to a decrease in willingness to learn due to a sense of isolation and a decrease in willingness to learn due to difficulty in arousing a competitive spirit.

### BRIEF SUMMARY OF THE INVENTION

It is an object of the present invention to provide a learning support method and learning support system which can provide a learning environment that prevents each learner from having a sense of isolation and an opportunity to arouse a sense of competition among learners by virtually forming a “study room” recognized as improving efficiency in a cram school or the like.

According to embodiment of the present invention, there is provided a learning support method applied to a learning support system which comprises a server apparatus and a plurality of terminal apparatuses, the terminal apparatuses corresponding to a plurality of users respectively, the server apparatus distributing a learning material to each of the terminal apparatus, each of the users operating one of the terminal apparatuses in order to learn the learning material during the one of the terminal apparatuses accessing the server apparatus, the method comprising: (a) detecting an input operation by the each of the users, whenever the each of the users operates one of the terminal apparatus; (b) storing a learning history of the each of the users whenever the input operation is detected, the learning history including at least detail of the input operation and a first time period which is a time period from a starting time when the each of the users starts learning the learning material until when the input operation is detected, to obtain a set of learning histories corresponding to the each of the users and being stored from the starting time until when the each of the users finishes to learn the learning material; (c) retrieving, whenever a predetermined time period elapses from the starting time corresponding to a first user who is one of the users, at least one learning history, to obtain a retrieved learning history whose the first time period is equal to or nearly equal to a second time period from the starting time corresponding to the first user until when the predetermined time period elapses, from the set of learning histories corresponding to a second user who is another of the users; and (d) displaying at least the retrieved learning history on one of the terminal apparatuses corresponding to the first user.

According to embodiment of the present invention, there is provided a learning support system which comprises a server apparatus and a plurality of terminal apparatuses, the terminal apparatuses corresponding to a plurality of users respectively, the server apparatus distributes a learning material to each of the terminal apparatus, each of the users operate one of the terminal apparatuses in order to learn the learning material, the system comprising: a detection device configured to detect an input operation by the each of the users, whenever the each of the users operates one of the terminal apparatus; a storing device configured to store a learning history of the each of the users whenever the input operation is detected by the detection device, the learning history including at least detail of the input operation and a first time period which is a time period from a starting time when the each of the users starts learning the learning material until when the input operation is detected, to obtain a set of learning histories corresponding to the each of the users and being stored from the starting time until when the each of the users finishes to learn the learning material; a retrieving device configured to retrieve, whenever a predetermined time period elapses from the starting time corresponding to a first user who is one of the users, at least one learning history, to obtain a retrieved learning history whose the first time period is equal to or nearly equal to a second time period from the starting time corresponding to the first user until when the predetermined time period elapses, from the set of learning histories corresponding to a second user who is another of the users; a displaying device configures to display at least the retrieved learning history on one of the terminal apparatuses corresponding to the first user.

### BRIEF DESCRIPTION OF THE SEVERAL VIEWS OF THE DRAWING

FIG. 1 is a block diagram showing an example of the overall arrangement of a learning support system according to the first embodiment of the present invention;

FIG. 2 is a view showing a detailed example of personal information;

FIG. 3 is a detailed example of learning histories;

FIG. 4 is a flow chart for explaining the operation of the learning support system according to the present invention;

FIG. 5 is a flow chart for explaining the operation of the learning support system according to the present invention;

FIG. 6 is a view showing an example of screen display on a terminal apparatus;

FIG. 7 is a view showing the display screen in FIG. 6 in more detail;

FIG. 8 is a view showing a display example of learning histories;

FIGS. 9 to 12 are views showing detailed examples of symbols and images used when learning histories are displayed;

FIG. 13 is a view showing another display example of learning histories;

FIG. 14 is a view showing still another display example of learning histories;

FIGS. 15 and 16 are views showing detailed examples of symbols and images used when learning histories are displayed;

FIG. 17 is a block diagram showing an example of the overall arrangement of a learning support system according to the second embodiment of the present invention;

FIG. 18 is a block diagram showing an example of the overall arrangement of a learning support system according to the third embodiment of the present invention;

FIG. 19 is a block diagram showing an example of the arrangement of a server apparatus in FIG. 18;

FIG. 20 is a view showing another example of learning histories;

FIG. 21 is a view showing an example of grade data;

FIG. 22 is a view showing another example of screen display on a terminal apparatus of a learner;

FIG. 23 is a flow chart for explaining the operation of the learning support system in FIG. 19 in a case wherein a comment or question is input by a user (learner); and

FIG. 24 is a flow chart for explaining qualification diagnosis processing in a certified device in the learning support system in FIG. 19.

### DETAILED DESCRIPTION OF THE INVENTION

The embodiments (first to third embodiments) of the present invention will be described below with reference to the views of the accompanying drawing.

An outline of a learning support system according to the first to third embodiments will be briefly described first.

In a “study room” in a cram school or the like which is recognized to have improved learning efficiency, the efficiency is probably improved by the following three factors: (1) a given learner's willingness to learn is aroused by the presence of other learners who are learning around the given learner, even though they do not exchange any words; (2) seeing a person who is learning at a pace equal to or slightly higher than that of a given learner stirs sense of competition in him, even though they do not exchange any words; and (3) paying attention to each other will make them communicate with each other even at a trivial opportunity, even though they have not exchanged any words so far.

In order to virtually create a “study room” having the three factors described above, the present invention has the following characteristics. The time is measured between the instant at which each user (learner) starts learning a learning material and the instant at which he performs input operation indicating the progress of learning of the learning material. This input operation is then recorded as a learning history in correspondence with the elapsed time from the start of learning to the input operation. When a given learner A is to learn a learning material, learning histories corresponding to the elapsed time which is measured from the instant at which the learner A starts learning are retrieved from the learning histories recorded when a plurality of other learners learnt in the past on the basis of the same learning material, and the retrieved learning histories are presented to the terminal of the learner A. This produces an atmosphere that makes the learner A feel the presence of other learners learning around him, even though they cannot exchange any words as indicated by (1).

In addition, by preferentially presenting the learning histories to another learner who is similar to the learner A in terms of the speed at which a learning material is completed, a situation that arouses the learner A sense of competition against the other learner is produced. This stirs competitive spirit in the learner A, as indicated by (2).

Furthermore, an asynchronous communication means is provided by presenting the contact information of each learner whose learning histories are presented to learner A. This can support building a friendship like a rival relationship between the learners, as indicated by (3).

First Embodiment

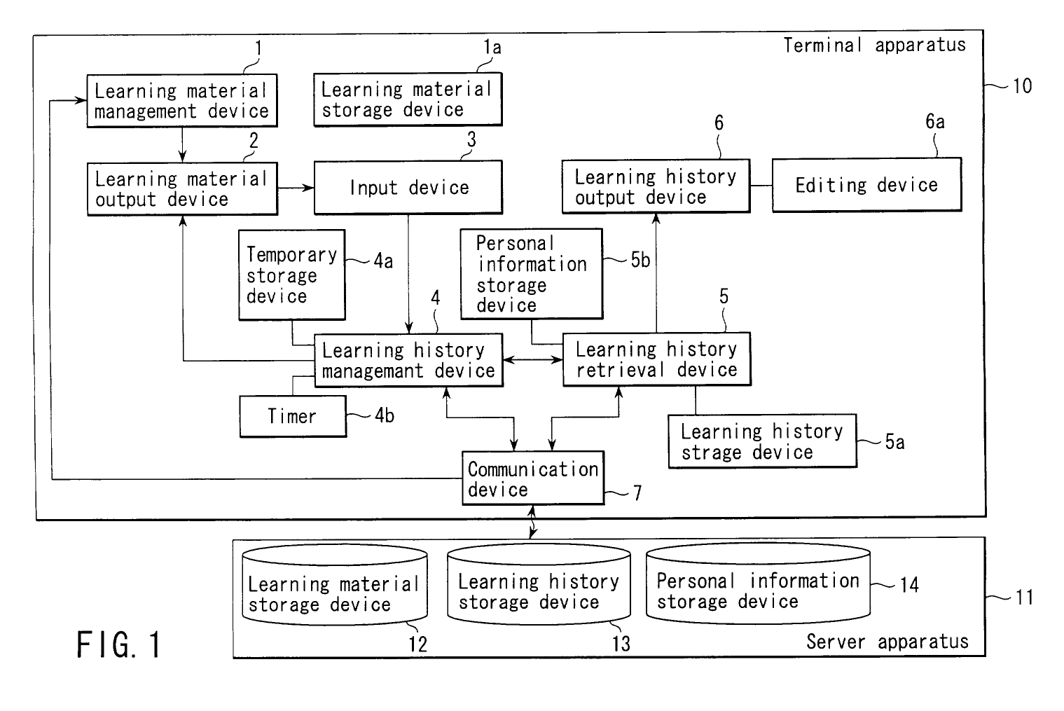

FIG. 1 shows an example of the overall arrangement of a learning support system according to the first embodiment, which roughly is comprised of a terminal apparatus 10 of a learner and a server apparatus 11 for communication with the terminal apparatus 10.

Learning materials constituted by sounds, videos, and sentences prepared in advance are stored in a learning material storage device 12 of the server apparatus 11. Each learning material is comprised of a plurality of data items corresponding to lectures and drills, scenarios by which the learner switches the data items, and the like. The server apparatus 11 transmits learning materials stored in the learning material storage device 12 to the terminal apparatus 10.

A learning history storage device 13 stores and uniformly manages the learning histories based on input operation on the terminal apparatuses 10 by all the learners who are learning on the basis of the learning materials sent from the server apparatus 11. Each learning history is recorded on the corresponding terminal apparatus in accordance with the elapsed time from the start of learning by the corresponding learner.

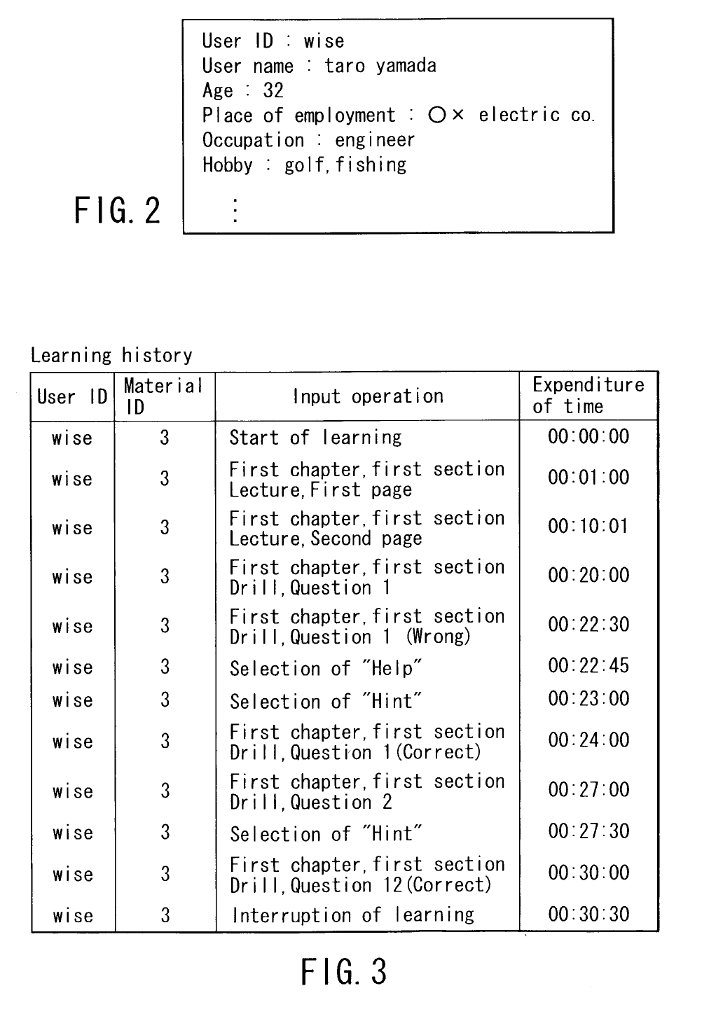

As shown in FIG. 2, personal information such as the identifier (user ID) of each learner, user name, age, and place of employment is stored in a personal information storage device 14.

When the terminal apparatus 10 communicates with the server apparatus 11 through the communication device 7, a learning material stored in the learning material storage device 12 is downloaded from the server apparatus 11 into a learning material management device 1 and stored in a learning material storage device 1a.

Assume that in the following description, the user ID of a learner who starts the learning support system and learns by using the terminal apparatus 10 is “X”, and the learner will be called the learner X when he/she needs to be differentiated from other learners.

The learning material stored in the learning material storage device la is presented to the learner X by a learning material output device 2 using, for example, a display or loudspeaker.

For example, as shown in FIG. 6, the learning material is displayed on the display by the learning material output device 2. For example, the display screen shown in FIG. 6 is comprised of a first display window 101 for displaying a learning material and a second display window 102 for displaying the learning histories retrieved in accordance with the progress of learning by the learner X.

The first display window 101 has a plurality of display areas 103 to 106, various operation buttons, and the like which are not shown in FIG. 6. A material ID for identifying each learning material stored in the learning material storage device 12 and its name are displayed in the display area 103. Information indicating a specific part (e.g., a chapter, unit, etc) of the learning material corresponding to the material ID displayed in the display area 103 is displayed in the display area 104. An expenditure of time (to be described later) is displayed in the display area 105. Data items of learning materials for which a scenario is determined depending on the progress of learning by the learner X are displayed in the display area 106. As described above, the first display window 101 is comprised of various display areas and various operation buttons which are necessary for the learner to progress learning on the basis of provided learning materials.

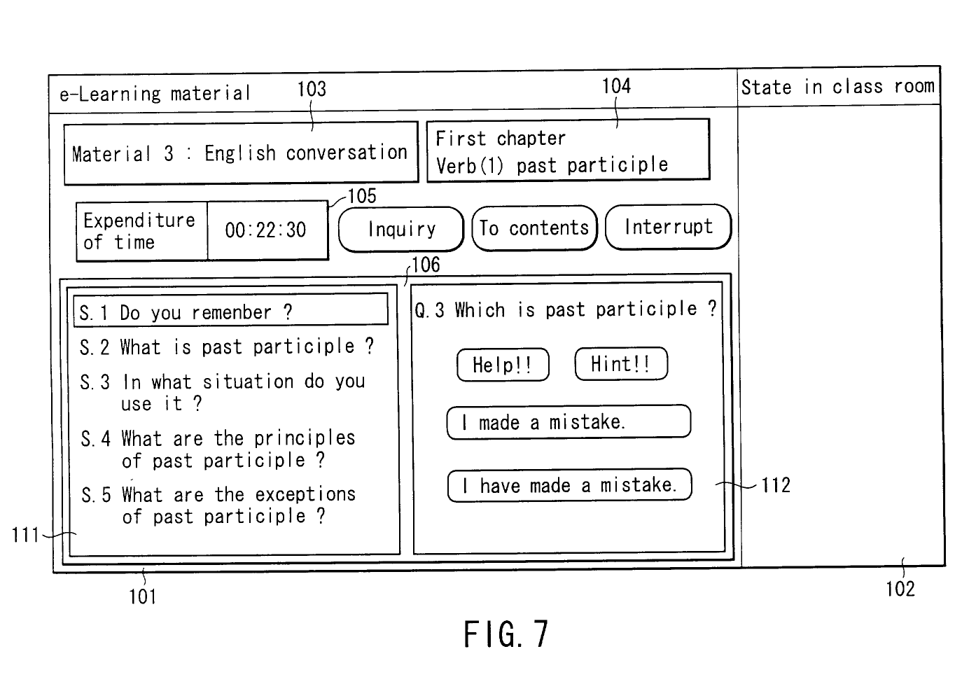

In the case of a lecture, data items such as a text which the learner should read is displayed in the display area 106. In the case of a drill, for example, as shown in FIG. 7, a drill range and a question are respectively displayed in a display area 111 and display area 112 in the display area 106.

The data based on various operations done by the learner X using a keyboard, mouse, microphone, and the like are input to an input device 3. For example, selection of a learning material presented by the learning material output device 2, an answer at the time of a drill are input, and selection of various buttons provided on the first display window 101 as shown in FIG. 6 are input through the input device 3.

A learning history management device 4 includes a temporary storage device 4a for temporarily storing the learning histories of the learner X and a timer 4b for measuring the elapsed time after the start of learning by the learner X in terms of an expenditure of time. When the learner X performs input operation through the input device 3, the learning history management device 4 detects the input operation and reads the time when the input operation is done from the timer 4b, and stores the time and detail of the input operation as the learning history of the learner X in the temporary storage device 4a.

FIG. 3 shows a learning histories, each of which is comprised of the user ID of the learner, the material ID of the learning material learnt by the learner, input operation, and expenditure of time.

The learning histories shown in FIG. 3 tell the following. A learner having the user ID “wise” started taking a lecture of the first page of the first section of the first chapter, at the expenditure of time “1 min” after he/she started learning a learning material having the material ID “3”. At the expenditure of time “10 min 1 sec”, the learner advanced to a lecture of the second page of the first section of the first chapter. At the expenditure of time “20 min”, the learner started taking a drill in the first section of the first chapter and solved the first question “question 1”. Thereafter, the learner advances to “question 1” and “question 2”. When correctly solving “question 2”, the learner interrupted the learning at the expenditure of time “30 min 30 sec”.

Assume that a learning material having one material ID is constituted by a plurality of chapters, and each chapter is constituted by a plurality of sections. In this case, the start point of an expenditure of time (i.e., the initial state represented by “00:00:00”) may be the start time of learning of the first chapter of a learning material having one material ID or the start time of learning of each chapter of a learning material having one material ID. That is, an expenditure of time may be measured for each learning material having one material ID or for each chapter. A case wherein an expenditure of time is measured for each learning material having one material ID will be described below. However, the present invention is not limited to this.

Assume that the learner X starts the learning support system according to this embodiment on the terminal apparatus 10, and selects the material ID “3”. At this time, the learning history management device 4 communicates with the server apparatus 11 through a communication device 7 to inquire about learning histories corresponding to the material ID “3”, which are the learning histories of the learner X. If the learning histories corresponding to the inquiry exist in the learning history storage device 13 of the server apparatus 11, the server apparatus 11 transmits them to the terminal apparatus 10. Upon reception of the learning histories transmitted from the server apparatus 11 through the communication device 7, the terminal apparatus 10 stores the learning histories in the temporary storage device 4a.

When the learner X stops (or interrupts) the learning afterward, the learning histories of the learner X which have been stored in the temporary storage device 4a are transmitted to the server apparatus 11 through the communication device 7. The server apparatus 11 stores the received learning histories of the learner X in the learning history storage device 13.

Assume that the learner X starts the learning support system according to this embodiment on the terminal apparatus 10 and selects, for example, the material ID “3”. At this time, the terminal apparatus 10 communicates with the server apparatus 11 through the communication device 7 and inquires about the learning histories of another learner different from the learner X, which was recorded when he/she learnt the learning material with the material ID “3”. If the learning histories corresponding to the inquiry exist in the learning history storage device 13 of the server apparatus 11, they are downloaded into the terminal apparatus 10 and stored in a learning history storage device 5a. The personal information of the other learner corresponding to the downloaded learning histories is also read out from the personal information storage device 14 and downloaded from the server apparatus 11. This information is then stored in a personal information storage device 5b of the terminal apparatus 10. Assume that at this time, the personal information of the learner X himself/herself who has started the learning support system is downloaded, together with the personal information of the other learner, and stored in the personal information storage device 5b of the terminal apparatus 10.

Assume that the elapsed time after the learner X has started learning the learning material with the material ID “3” is started to be measured as an expenditure of time. At this time, the expenditure of time measured by the timer 4b is the elapsed time after the start of learning of the first chapter of the learning material with the material ID “3”. In addition, the learning histories of the other learner who learnt the learning material with the material ID “3” in the past are stored in the learning history storage device 5a of a learning history retrieval device 5. The personal information of such another learner is stored in the personal information storage device 5b.

The learning history retrieval device 5 retrieves a learning history corresponding to the same expenditure of time as that measured by the timer 4b from the learning histories stored in the learning history storage device 5a. In this case, other learners similar in age, hobby, occupation, and the like to the learner X may be selected in advance on the basis of the personal information stored in the personal information storage device 5b, and a learning history corresponding to the same expenditure of time as that measured by the timer 4b may be retrieved from the learning histories of the selected learners.

A learning history is retrieved every time an expenditure of time, e.g., 1 sec, 1 min, or 10 min, elapses (updated). In this case, for example, a learning history is retrieved every second. However, the present invention is not limited to this. This retrieval time can be changed as needed by setting made by the learner. Assume that a retrieval time setting window is provided, and such a retrieval time is set on the basis of the time input on the setting window.

A learning history output device 6 is used to output (display) the learning histories retrieved by the learning history retrieval device 5. The learning histories are output after being edited as needed. The retrieved learning histories are displayed in the second display window 102 shown in FIGS. 6 and 7.

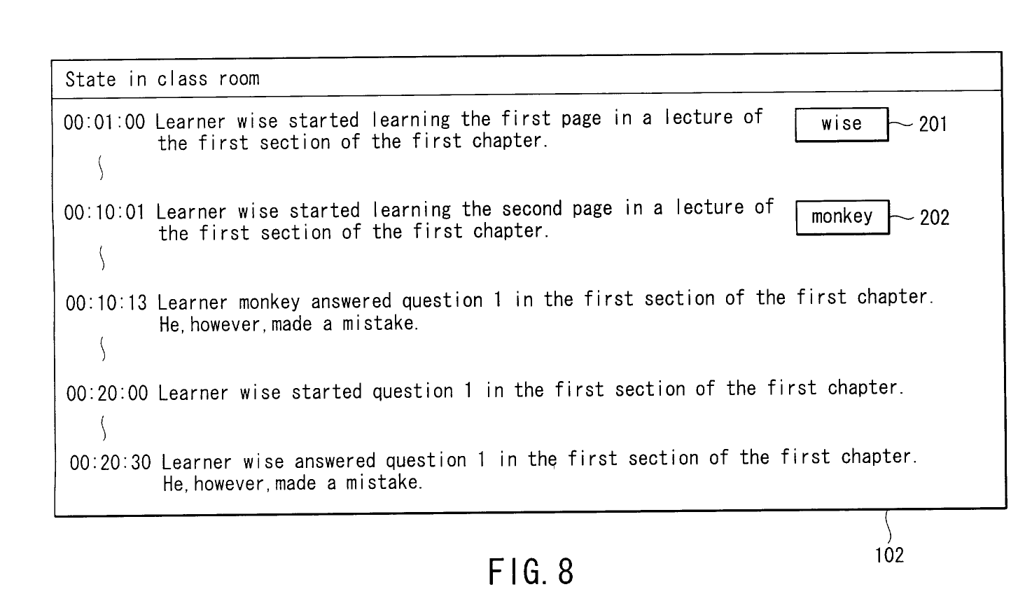

The display screen shown in FIG. 7 is an example of display in a case wherein the learner X is taking a question in the first section of the first chapter of the learning material with the material ID “3”. The question “3” which is currently solved by the learner X is displayed in the display area 112 in the display area 106 of the first display window 101, and a range that covers the question “3” is displayed in the display area 111 adjacent to the display area 112. The current expenditure of time “00:22:30” is displayed in the display area 105. At this time, the learning histories retrieved by the learning history retrieval device 5 are displayed in the second display window 102 by the learning history output device 6, as shown in, for example, FIG. 8.

That is, when the expenditure of time by the learner X changes from 22 min 29 sec (“00:22:29”) to 22 min 30 sec (“00:22:30”), the learning history retrieval device 5 retrieves a learning history corresponding to an expenditure of time of 22 min 30 sec from the learning histories stored in the learning history storage device 5a. Assume that in this case, the learning histories corresponding to the user ID “wise” shown in FIG. 3 are stored in the learning history storage device 5a, and a learning history corresponding to an expenditure of time of 22 min 30 sec exists in these learning histories. The input operation corresponding to this learning history is “first chapter first section drill question 1 (wrong)”. An editing device 6a of the learning history output device 6 edits this learning history into the sentences “The learner wise answered question 1 in the first section of the first chapter. However, he made a mistake.” These sentences are displayed at the end of the learning histories in the second display window 102, as shown in FIG. 8.

As shown in FIG. 8, buttons 201 and 202 corresponding to the respective learners corresponding to the learning histories displayed in the second display window 102 may be set in the second display window 102. When one of these buttons 201 and 202 is selected by, for example, clicking with the mouse, the contact information of the learner corresponding to the selected button is presented. It is to be expected that this operation will make the learner find a common ground to another learner in whom the learner is interested in terms of “similar ability” or “noteworthy” and reduce the sense of isolation.

In presenting a learning history, the history may be output in the form of sound, symbol, picture, or the like instead of a sentence as in the above case. In addition, such a learning history may be output in the form of an imitation sound like the sound made when the learner turns over a page or vibrations as well as being output as a sentence.

As described above, learning histories have detailed contents obtained by recording each input operation by the learner. If, therefore, the contents of every input operation are loosely displayed without any change as an expenditure of time elapses, the contents become too elaborate to look at. When presenting learning histories, therefore, unimportant learning histories may be omitted or several associated learning histories may be combined to be output as one sentence. Assume that the learner solved a given question wrongly twice and solved correctly third time. In this case, a plurality of learning histories recorded (the learning histories of all input operations done to answer the question until a correct answer is obtained) are combined into one learning history. When the learning histories about the first and second answers are retrieved, they are not displayed. When the learning history about the third answer which is the correct answer is retrieved, for example, the sentence “Although the learner answered wrong twice, he made a correct answer at the third attempt” is output. In this manner, learning histories may be summarized upon display.

As described above, the learning history retrieval device 5 and learning history output device 6 are started from the start of learning by the learner X along an elapse of an expenditure of time, and are started regardless of whether the learner X performs input operation through the input device 3.

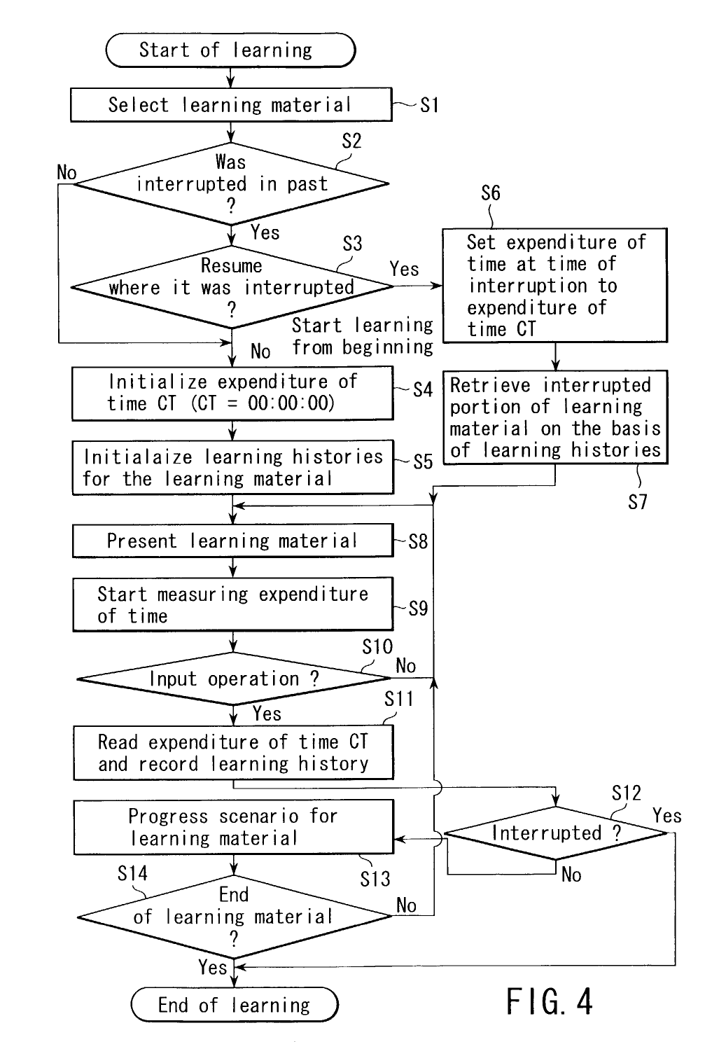

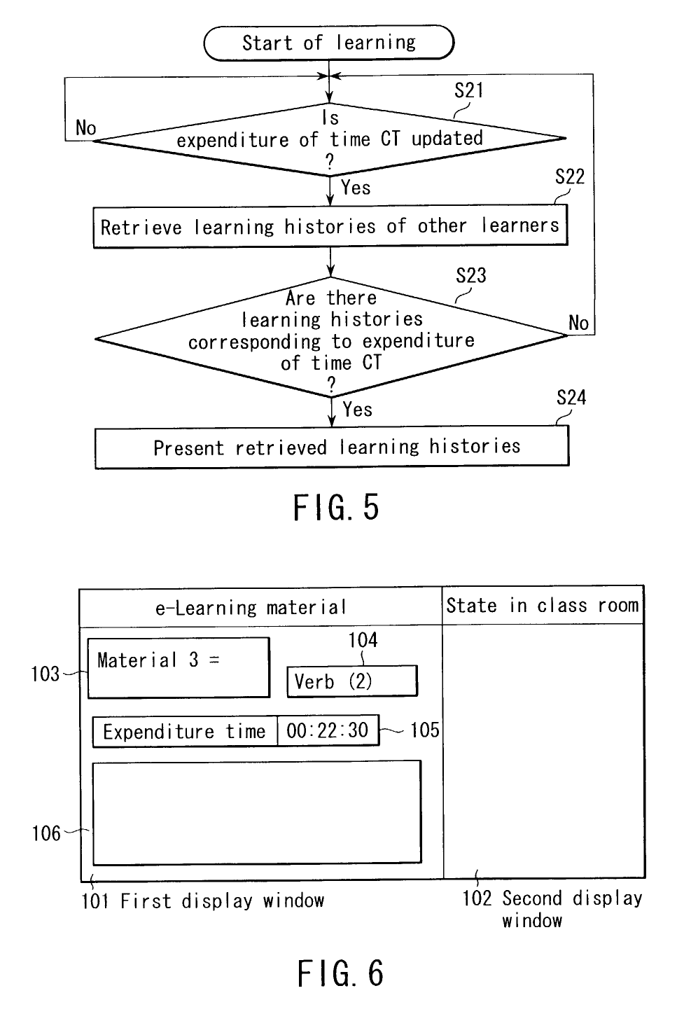

The operation of the learning support system in FIG. 1 will be described next with reference to the flow charts of FIGS. 4 and 5.

The operation of components, of the components of the learning support system in FIG. 1, which depend on input operation by the learner X will be described first with reference to FIG. 4.

Upon starting the learning support system with the terminal apparatus 10, the learner X selects the learning material “3” through the input device 3 (step S1)

Assume that the learning material with the material ID “3” is stored in the learning material management device 1 in advance.

Upon this selection, the learning history management device 4 communicates with the server apparatus 11 through the communication device 7 to inquire of the server apparatus 11 about the learning histories of the learner X which correspond to the material ID “3”. If the learning histories corresponding to the inquiry exist in the learning history storage device 13, the server apparatus 11 transmits them to the terminal apparatus 10. The terminal apparatus 10 receives the learning histories and stores them in the temporary storage device 4a. If there are no learning histories corresponding to the inquiry in the learning history storage device 13 of the server apparatus 11, it indicates that the learner X starts learning the learning material with the material ID “3” for the first time. In this case, therefore, if a response message indicating that the learning histories do not exist in the learning history storage device 13 is received from the server apparatus 11 (step S2), the flow advances to step S4.

In step S4, the timer 4b is initialized to set an expenditure of time CT to 0 hr 0 min 0 sec “00:00:00”. In addition, the learning histories are initialized by, for example, ensuring an area in the temporary storage device 4a in which the learning histories concerning the learning material with the material ID “3” (step S5). Thereafter, the learning material output device 2 presents learning materials (step S8), and the timer 4b starts measuring an expenditure of time (step S9).

If it is determined in step S2 that there are learning histories of the learner X which correspond to the material ID “3” in the learning history storage device 13 of the server apparatus 11, the terminal apparatus 10 receives the learning histories and stores them in the temporary storage device 4a. In this case, since the learner X interrupted the learning corresponding to the material ID “3” in the past, the learner X is inquired first whether he will resume learning from the portion where he interrupted or make a fresh start from the first (from the first chapter) (step S3). If the learner X operates the input device 3 to perform input operation indicating that he will make a fresh start, the flow advances to step S4. If the learner X performs input operation indicating that he will resume learning from the portion where he interrupted, the flow advances to step S6.

In step S6, the expenditure of time included in a learning history, of the learning histories of the learner X concerning the learning material with the material ID “3” received in advance, which corresponds to “interruption of learning” as input operation, is set in the timer 4b (step S6). The interrupted portion of the learning material is searched based on the learning history (step S7). Thereafter, the learning material output device 2 presents data items of the learning material which were presented to the learner X at the time of interruption (step S8). Measurement of an elapsed time (the expenditure of time) from the time of interruption which is set in the timer 4b is started (step S9).

When the data items of the learning material are presented, the learner X should perform some input operation in accordance with the contents displayed on the display screen. For example, the learner X may turn over a page (update) in the case of a lecture, or may input an answer when solving a question. When such input operation is done through the input device 3 (step S10), the learning history management device 4 detects the input operation and reads the expenditure of time measured by the timer 4b, and writes the detail of the input operation as a learning history in the form shown in FIG. 3, together with the expenditure of time, in the temporary storage device 4a (step S11). Assume that the learner X has selected, on the screen shown in FIG. 7, the “Hint” button that gives a hint for the question “3”. In this case, if the expenditure of time is “00:23:31”, a learning history containing this expenditure of time and detail of the input operation “selection of “Hint”” is written in the temporary storage device 4a.

The learning material management device 1 then progresses the scenario for the learning material (progresses learning). The learning material output device 2 presents the data items of learning materials to be presented next (step S13). If the learner X progresses learning and completes the learning material itself, the processing is terminated. Otherwise, the flow returns to step S10 to wait for next input operation while measuring an expenditure of time.

If the learner X performs input operation to interrupt the learning in step S10 (for example, selects the “interrupt” button in FIG. 7), a learning history including the input operation “interruption of learning” is recorded in step S11, and the flow advances to step S12.

In step S12, the learning history management device 4 transmits the learning histories of the learner X which have been stored in the temporary storage device 4a so far to the server apparatus 11, and terminates the processing.

The operation of components, of the respective components of the learning support system in FIG. 1, which depend on an elapse (updating) of an expenditure of time instead of input operation by the learner X will be described next with reference to the flow chart of FIG. 5.

Assume that the expenditure of time is updated by 1 sec (step S21). Assume that the expenditure of time by the learner X is updated from 22 min 29 sec (“00:22:29”) to 22 min 30 sec (“00:22:30”). In this case, the learning history retrieval device 5 retrieves a learning history corresponding to an expenditure of time of 22 min 30 sec from the learning histories stored in the learning history storage device 5a (step S22).

In this case, when a learning history is to be retrieved, other learners similar in age, hobby, occupation, and the like to the learner X may be selected in advance on the basis of the personal information stored in the personal information storage device 5b, and a learning history corresponding to the same expenditure of time as that measured by the timer 4b may be retrieved from the learning histories of the selected learners.

In addition, of the learning histories of the learner X which are stored in the temporary storage device 4a and the learning histories stored in the learning history storage device 5a, learning histories similar to those of the learner X, which are stored in the temporary storage device 4a, in terms of an expenditure of time, the progress of learning, input operation, and the like may be selected in advance. Alternatively, a learning history similar to that of the learner X, which is stored in the temporary storage device 4a, in terms of the progress of learning, input operation, and the like may be selected from the learning histories obtained by retrieving learning histories corresponding to the same expenditure of time as that measured by the timer 4b.

In this manner, if there is a learning history having the same expenditure of time as the measured expenditure of time every time the expenditure of time is updated (step S23), the learning history is presented by the learning history output device 6 (step S24). If it is determined in step S23 that there is no learning history having the same expenditure of time as the measured expenditure of time, the flow returns to step S21 to wait until the expenditure of time is updated.

If it is determined in step S23 that there is no learning history having the same expenditure of time as the expenditure of time corresponding to the learner X, the editing device 6a may generate and present a learning history that arouses a spirit of competition of the learner X in accordance with the progress of learning by the learner X (on the basis of the learning histories of the learner X). In addition, the editing device 6a may present a learning history having an expenditure of time similar to the expenditure of time corresponding to the learner X upon rewriting it. Furthermore, even if there is a learning history having the same expenditure of time as the expenditure of time corresponding to the learner X, the editing device 6a may generate a learning history different from the retrieved learning history and present it. Alternatively, the editing device 6a may rewrite the retrieved learning history and present it.

If, for example, the learner X does not input an answer to the question “3” for a long period of time (a predetermined period of time elapses without any input operation), the editing device 6a generates a sentence like “a learner A gave a correct answer to the question “3”” or “a learner A gave a wrong answer to the question “3””. Such sentences generated in this manner may be sequentially displayed in the second display window 102 in FIG. 7 as the expenditure of time is updated.

When the learning histories of other learners who are similar to the learner X in terms of the progress of learning are sequentially displayed in this manner, it can produce an atmosphere that makes the learner X feel the presence of other persons who are learning around him, although he cannot exchange words with them. In addition, this can produce a situation that arouses a feeling of competition of the learner X against other learners.

When, for example, a learning material is completed (e.g., all the chapters with the material ID “3” are completed), the contact information of a desired learner of other learners corresponding to the learning histories presented during learning of the learning material may be presented. In addition, among such other learners, the contact information of a learner who is making a progress similar to that of the learner X or of a learner to whom the learner X pays attention may be presented. Furthermore, the learner X may be allowed to select a desired learner from other presented learners, and the learning histories of the selected learner may be preferentially presented from this time forth. It can be expected that presenting such information will help a given learner to find a common ground with another learner in whom the given learner is interested in terms of “similar ability” or “noteworthy” and reduce the sense of isolation.

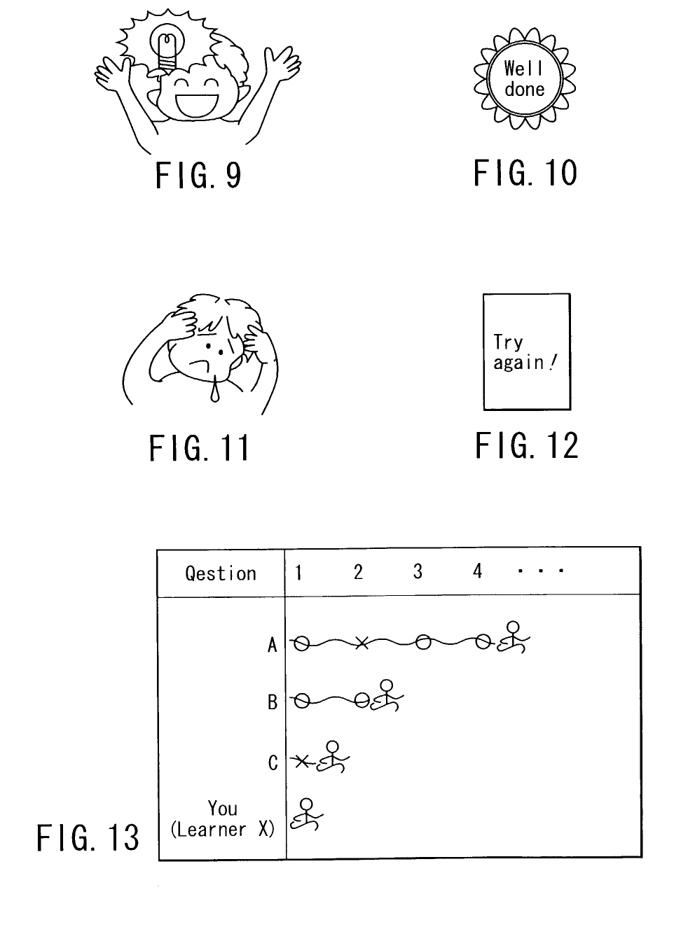

In addition, at the end of learning by the learner X, the learning history management device 4 or the server apparatus may compared the learning histories of the learner X with those of other learners, and any characteristic that is found in the learning histories of the learner X may be pointed out. If, for example, the learner X completes learning in the shortest expenditure of time ever recorded, he is honored as achieving learning speed “No. 1”. It can be expected that this will arouse a feeling of competition, reduce the sense of isolation, and enhance the motivation. Likewise, if, for example, the learner X records the highest percentage of correct answers to questions in the past (e.g., records a percentage of correct answers equal to or more a predetermined value) or completes questions in the shortest time in the past (e.g., completes questions in an expenditure of time equal to or less than a predetermined value), a corresponding message may be displayed or a symbol or image that is intuitively easy to understand may be displayed as shown in FIGS. 9 and 10. In contrast, if the percentage of correct answers to questions is the lowest in the past (e.g., the percentage of correct answers is equal to or less than a predetermined value), or questions are completed in the longest time (e.g., an expenditure of time equal to more than a predetermined value is required to complete questions), a corresponding message may be displayed or a symbol or image that is intuitively easy to understand may be displayed as shown in FIGS. 11 and 12.

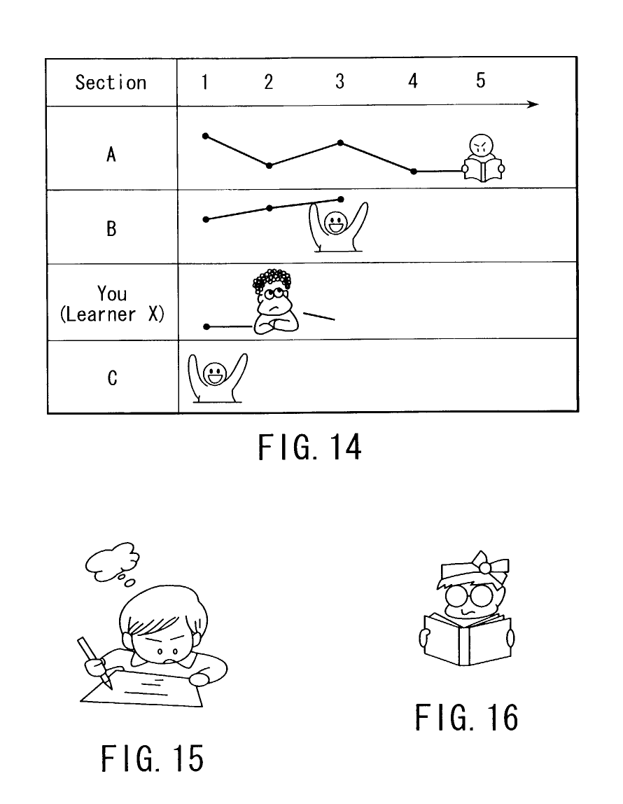

In the above embodiment, learning histories are displayed in the second display window 102, as shown in FIG. 8. However, the display form of learning histories is not limited to such a text form. For example, learning histories may be displayed in a form that allows a learner to intuitively compare, at a glance, the progress, grade, and the like of the learner with those of other learners at the current point of time, as shown in FIGS. 13 and 14.

The display forms of learning histories shown in FIGS. 13 and 14 will be described below.

Learning histories associated with answers to questions are selected from the learning histories retrieved in step S22. Referring to FIG. 13, the selected learning histories are displayed in the form of an image for the respective learners. FIG. 13 shows the learning histories of the learner X in the same manner. As is obvious from FIG. 13, a learner A has progressed to the question “4” in the current expenditure of time by the learner X, and has learnt fastest. The learner A obtained correct answers to all questions, except for “question 2”, at one try. In contrast, the learner X is now solving the first question. It can be expected that the learner X will reflect on the learning speed of himself upon seeing this, and be motivated to learn harder.

Referring to FIG. 14, the learning histories retrieved in step S22 are displayed in the form of an image for the respective learners in order to readably display the progress of each learner. In this case, the points of the line graph corresponding to each learner represent the percentages of correct answers to questions in the respective sections. At the portion corresponding to the current expenditure of time by the learner X, i.e., the head of the line graph, a symbol that represents a learning history of each learner which corresponds to the current expenditure of time by the learner X is displayed. In the case of the learner A, for example, the symbol shown in FIG. 15 is displayed, which expresses that the learner is now taking the lecture of the fifth section. In the case of a learner B, learning is interrupted at the end of the third section. Although not shown in FIG. 14, if a given learner performs no input operation after starting a question, a symbol like the one shown in FIG. 16 may be displayed.

In order to display learning histories in the forms shown in FIGS. 13 and 14, the editing device 6a must edit the learning histories in the above manner.

As described above, in the above embodiment, the learning history based on input operation by the first user (learner X) who is learning on the basis of learning materials is recorded in correspondence with the elapsed time (measured expenditure of time) after the start of learning. Every time a predetermined period of time elapses after the start of learning of a given learning material (e.g., every time an expenditure of time of 1 sec elapses), learning histories of a plurality of second users (other learners) which correspond to the period of time (expenditure of time) spent after the start of learning by the first user (have the same expenditure of time as that by the first user) are retrieved from the learning histories recorded when the second users learnt on the basis of the learning material, and the retrieved learning histories are presented.

In this manner, the learning histories of the second users (other learners) are presented (supplied) to the first user (learner X) to produce an atmosphere that makes the first user feel the presence of people learning around him, even though the first user cannot exchange words with them.

The learning histories of the second users (other learners) may be presented to the first user (learner X), if the first user (learner X) requests to do so. In this case, when learner X input the request to present the learning histories of other learners by operating the terminal apparatus 10, the learning history retrieval devices 5 retrieves and presents the retrieved learning histories of other learners to the learner X.

If the learning histories presented to the first user are those of the second user who is similar to the first user in terms of occupation, age, and the like, or are similar to those of the first user, it can produce a situation that arouses a feeling of competition of the first user against the second user.

Furthermore, presenting a given learner not only learning histories but also the contact information of each learner corresponding to the learning histories, makes it easy to communicate with a person in whom the given learner is interested.

According to the present invention, there is provided a system which reduces the sense of isolation felt by a learner who takes distance learning and maintains the motivation to continue learning by presenting the learning histories of other learners together with learning materials. According to the present invention, therefore, a learner can receive only the merits of distance learning without feeling any demerits. This will reduce the number of learners who quit learning halfway and make it easy for learners to allocate free time to learning. As a consequence, the knowledge and technical level of people can be improved.

Second Embodiment

Only portions different from those of the first embodiment will be described below.

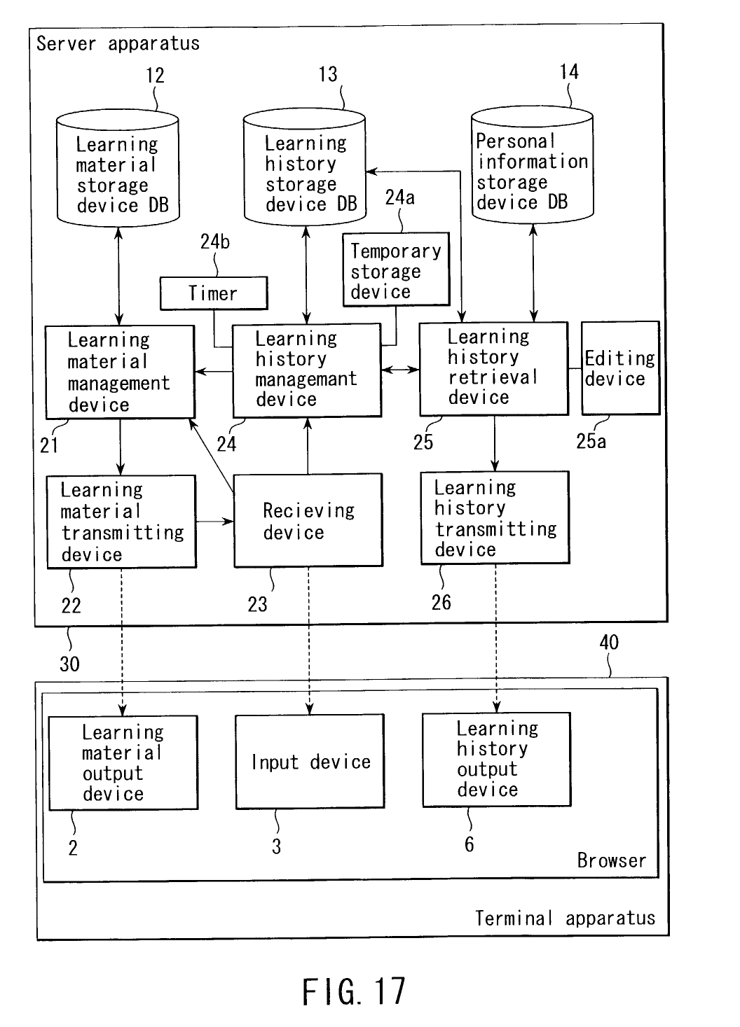

FIG. 17 shows an example of the arrangement of a learning support system according to the second embodiment. The same reference numerals as in FIG. 17 denote the same parts in FIG. 1, and only different portions will be described.

The arrangement shown in FIG. 17 is comprised of a server apparatus 30 and a terminal apparatus 40 serving as a client. A learner X learns by using the terminal apparatus 40.

Of the components shown in FIG. 17, components having the same functions as those in the first embodiment are denoted by the same reference numerals. For the sake of convenience, the editing device 6a described in the first embodiment is connected to a learning history retrieval device instead of a learning history output device in the second embodiment.

The server apparatus 30 provides a learning material and measures the expenditure of time by the learner X in accordance with a request from the terminal apparatus 40. Upon reception (detection) of input operation based on the provided learning material, the server apparatus 30 records the learning histories of the learner X and retrieves learning histories as the expenditure of time is updated. The server apparatus 30 further edits the retrieved learning histories in a predetermined form that is displayed on the terminal apparatus 40, and transmits the resultant data.

The terminal apparatus 40 only displays the learning material provided by the server apparatus 30, performs input operation based on the presented learning material, and displays the learning histories provided by the server apparatus 30.

In the second embodiment, learning progresses while communication between the terminal apparatus 40 and the server apparatus 30 is performed through a predetermined network, e.g., the Internet. If the terminal apparatus 40 has a browser function, it can be easily formed of a learning material output device 2 which presents the learning material transmitted from the server apparatus 30, an input device 3 which inputs data based on each operation performed by using, for example, a keyboard, mouse, or microphone on the basis of the display screen for learning materials, and a learning history output device 6 which presents the learning histories transmitted (already edited) from the server apparatus 30. The terminal apparatus 40 can therefore be applied to a compact terminal apparatus such as a PDA (Personal Digital Assistant).

The server apparatus 30 includes a learning material storage device 12, learning history storage device 13, and personal information storage device 14 which are described in the first embodiment. In addition, the server apparatus 30 is comprised of a learning material output device 21, learning material transmitting device 22, receiving device 23, learning history management device 24, learning history retrieval device 25, and learning history transmitting device 26 to realize the function of the terminal apparatus 10 in the first embodiment.

When a material ID is sent to the server apparatus 30 through the input device 3 of the terminal apparatus 40, the server apparatus 30 receives it through the receiving device 23, and transfer it to the learning history management device 24.

The learning history management device 24 temporarily stores, in a temporary storage device 24a, the learning histories of the learner X of the terminal apparatus 40 which is currently performing communication. A timer 24b for measuring the elapsed time, as an expenditure of time, after the learner starts the learning, is connected to the learning history management device 24. Upon reception of input operation by the learner X through the receiving device 23, the learning history management device 24 detects the detail of the input operation and reads the expenditure of time at the time of the input operation from the timer 24b. The learning history management device 24 then temporarily stores the detail of the input operation in the temporary storage device 24a, together with the expenditure of time, as the learning history of the learner X.

For example, upon reception of the material ID “3” selected by the learner X from the receiving device 23, the learning history management device 24 checks whether there are any learning histories which are those of the learner X and correspond to the material ID “3” in the learning history storage device 13. If there are such learning histories, the learning history management device 24 reads them out and stores them in the temporary storage device 24a.

When the learner X stops (or interrupts) the learning, the learning history management device 24 receives the corresponding information from the receiving device 23. The learning history management device 24 then stores the learning histories of the learner X stored in the temporary storage device 24a in the learning history storage device 13.

Upon reception of the material ID “3” selected by the learner X from the receiving device 23, the learning material output device 21 reads out a learning material with the material ID “3” from the learning material storage device 12. The learning material output device 21 then transmits this readout learning material in a necessary amount to the terminal apparatus 40 which is the request source through the learning material transmitting device 22. In this case, it suffices if only the data items to be presented next are transmitted on the basis of input operation by the learner X and a scenario for the learning material.

Every time the expenditure of time (elapsed time) measured by the timer 24b updated, the learning history retrieval device 25 retrieves a learning history having the same expenditure of time as that at this time, from the learning history storage device 13. In this case, the learning history retrieval device 25 may select other learners who are similar to the learner X in terms of age, hobby, occupation, and the like in advance on the basis of the personal information stored in advance in the personal information storage device 14. The learning history retrieval device 25 may then retrieve a learning history having the same expenditure of time as that measured by the timer 24b from the learning histories of the selected learners.

An editing device 25a then converts the learning history retrieved in this manner into a sentence that is easy for the user to read as in the first embodiment or in an image-like display form as shown in FIGS. 13 and 14. The resultant data is transmitted to the terminal apparatus 40 through the learning history transmitting device 26.

The operation of the server apparatus 30 for one terminal apparatus 40 is almost the same as that in the flow charts of FIGS. 4 and 5.

As described above, according to the second embodiment, even if the terminal apparatus 40 is a compact, portable communication terminal having a small memory capacity, the learning support system described in the first embodiment can be realized by making the server apparatus 30 perform main operation.

In the first and second embodiments, learning histories to be presented to a learner are retrieved from the learning histories actually stored in the learning history storage device 13. However, the present invention is not limited to this. For example, in step S22 in FIG. 5, every time the expenditure of time by the learner elapses, a learning history suitable for the current state of the learner is generated on the basis of the learning histories of the learner without retrieving any learning history. This learning history may be presented upon being converted into a predetermined form, as needed.

Third Embodiment

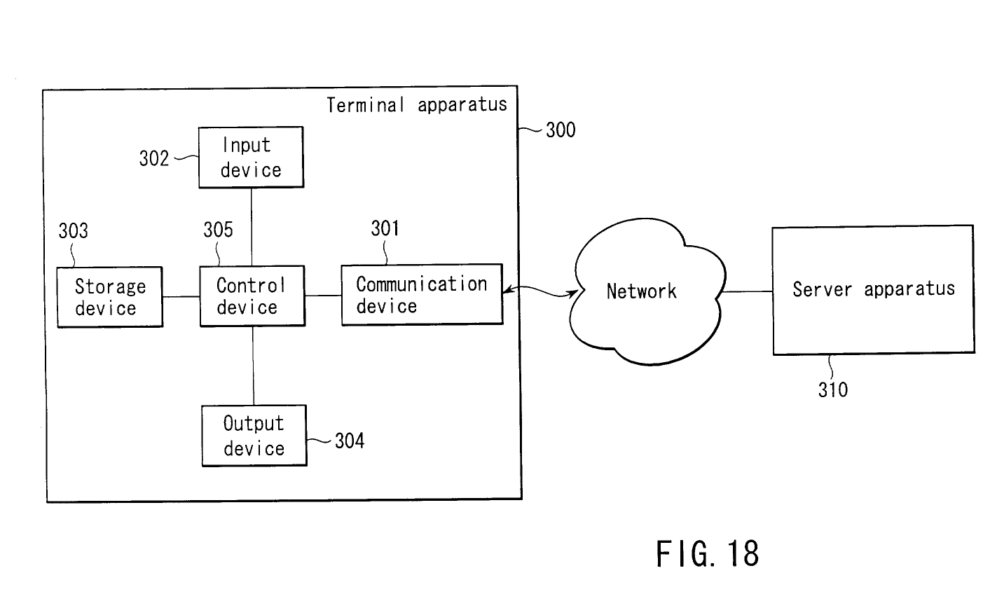

FIG. 18 shows an example of the overall arrangement of a learning support system according to the third embodiment. As shown in FIG. 18, the learning support system is comprised of a server apparatus 310 and a terminal apparatus 300 that is one of a plurality of terminal apparatuses serving as clients. A learner X learns by using the terminal apparatus 300.

The server apparatus 310 is installed in, for example, an educational institution extension center.

The terminal apparatus 300 is comprised of a communication device 301, input device 302, storage device 303, output device 304, and control device 305.

Like the terminal apparatus 40 in the second embodiment, this terminal apparatus 300 only displays the learning materials provided from the server apparatus 310, performs input operation based on the presented learning material, and displays the learning histories provided from a server apparatus 110.

In the third embodiment, learning progresses while communication between the terminal apparatus 300 and the server apparatus 310 is performed through a predetermined network, e.g., the Internet. The terminal apparatus 300 may have a browser function. The output device 304 which presents the learning materials, learning histories, and the like transmitted from the server apparatus 310 and the input device 302 which inputs the data based on various operations performed by using, for example, a keyboard, mouse, and microphone on the basis of the display screen of learning materials can be easily formed. In addition, the storage device 303 which stores the learning materials and learning histories transmitted from the server apparatus 310, the learning histories of a user (e.g., the learner X) who learns by using the terminal apparatus 300, and the like can be easily formed by using a function originally incorporated in the terminal apparatus 300. The control device 305 controls the respective components described above to implement the functions of the learning support system and other functions on the terminal apparatus 300.

The terminal apparatus 300 can also be applied to a portable, compact terminal apparatus such as a PDA.

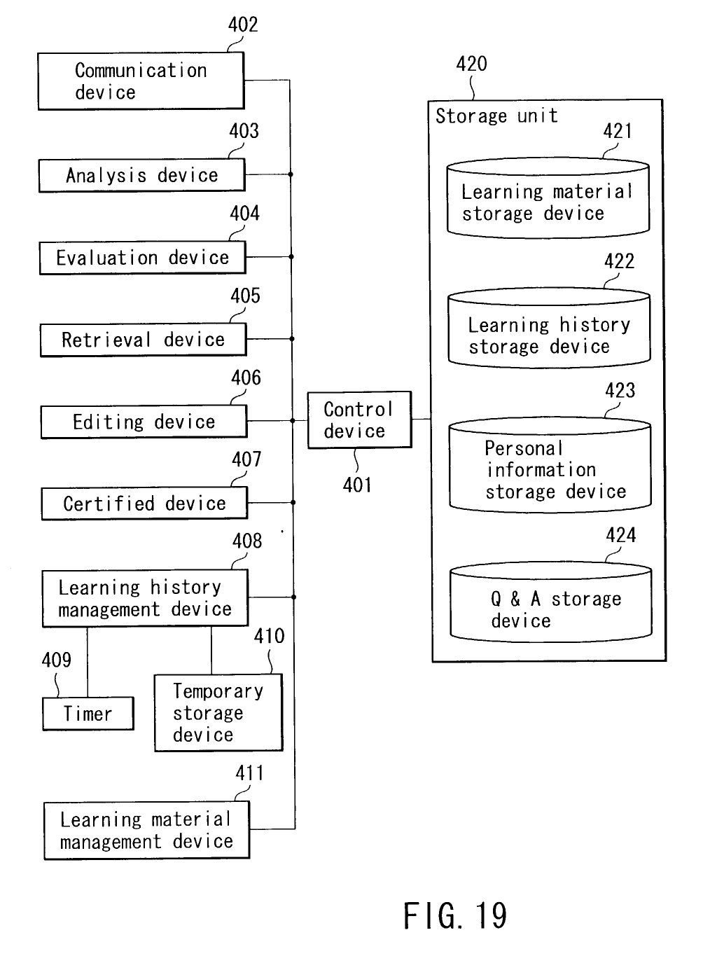

FIG. 19 shows the schematic arrangement of the server apparatus 310.

Referring to FIG. 19, the server apparatus 310 is comprised of a control device 401, communication device 402, analysis device 403, evaluation device 404, retrieval device 405, editing device 406, certified device 407, learning history management device 408, timer 409, temporary storage device 410, learning material management device 411, and storage unit 420.

The storage unit 420 is comprised of a learning material storage device 421, learning history storage device 422, personal information storage device 423, question-and-answer (Q & A) storage device 424.

The arrangement of the server apparatus 310 shown in FIG. 19 is expanded on the basis of the arrangement of the server apparatus 30 shown in FIG. 17 to add the following new functions. The followings are the new functions of the server apparatus 310 shown in FIG. 19. (1) The question and comment input by a learner in the process of learning are recorded as learning histories. (2) When the learner X inputs a question or comment in the process of learning, question or comments which are similar to or associated with the question or comment input by the learner X are retrieved from the learning histories recorded when other learners learned on the basis of the learning material in the past. The retrieved other question or comments are converted into utterances from other learners which correspond to the question or comment input by the learner X, and transmitted to the terminal apparatus 300. (3) It is checked whether the number and quality of question or comments input by each learner in the process of learning satisfy predetermined minimum standards. Any learner who dose not satisfy these minimum standards are excluded from the learning community.

The server apparatus 310 shown in FIG. 19 will be described below with particular emphasis on the above three new functions in which the server apparatus 310 differs from the server apparatus 30 shown in FIG. 17.

Although the server apparatus 310 shown in FIG. 19 includes the arrangement of the server apparatus 30 shown in FIG. 17, the reference numerals of components of these arrangements do not coincide with each other. The following description will therefore indicate the correspondence between the components of the server apparatus 310 in FIG. 10 and those of the server apparatus 30 in FIG. 17. Some of the components of the server apparatus 310 which correspond to some of the components of the server apparatus 30 have the same functions as those of the corresponding components of the server apparatus 30.

The learning material storage device 421 of the server apparatus 310 corresponds to the learning material storage device 12 in FIG. 17, in which learning materials are stored. The learning history storage device 422 corresponds to the learning history storage device 13 in FIG. 17, in which learning histories are stored. The personal information storage device 423 corresponds to the personal information storage device 14 in FIG. 17, in which personal information is stored.

The learning material management device 411 of the server apparatus 310 corresponds to the learning material output device 21 in FIG. 17. The learning history management device 408 corresponds to the learning history management device 24 in FIG. 17. The timer 409 corresponds to the timer 24b in FIG. 17. The temporary storage device 410 corresponds to the temporary storage device 24a in FIG. 17.

The retrieval device 405 of the server apparatus 310 corresponds to the learning history retrieval device 25 in FIG. 17. The editing device 406 corresponds to the editing device 25a in FIG. 17.

The control device 401 and communication device 402 of the server apparatus 310 can implement the functions of the learning material transmitting device 22, receiving device 23, and learning history transmitting device 26 in FIG. 17.

A portion associated with the above three new functions of the server apparatus 310 in FIG. 19 will be described below.

The learning material data stored in the learning material storage device 421 of the server apparatus 310 are distributed to the respective learners who are permitted to take part in the learning support system. The learning materials stored in the learning material storage device 421 are transmitted, through a network, to the terminal apparatus 300 of a learner who is permitted to take part in the learning support system. Alternatively, the learning materials are stored in the storage device 303 of the terminal apparatus 300 through a recording medium such as a CD-ROM.

The input device 302 of the terminal apparatus 300 is used to input necessary information such as a learner's request to take part in the learning support system, a request for learning material data, a comment, a question, and the like, information concerning operation done by the learner in the process of learner, and the like. If the learner has a question during learning or wants to know more detailed information, he inputs a request to communicate with another learner or a teacher, a question, a comment, or the like (which are generically called a message hereinafter) through the input device 302.

When the above message is input to the input device 302, the communication device 301 establishes a communication line between the terminal apparatus 300 and the server apparatus 310 to access the latter.

When the message sent to the server apparatus 310 through the network is received by the communication device 402, it is transferred to the analysis device 403. The analysis device 403 determines whether the message is a comment or a question. If the message includes an identifier indicating one of a comment and a question, the identifier may be referred to. Alternatively, the type of message may be determined by analyzing the contents of the message.

If the message is a question, the retrieval device 405 retrieves an answer to the question from the Q & A storage device 424. This retrieved answer is transmitted to the terminal apparatus 300 through the communication device 402.

The retrieval device 405 of the server apparatus 310 retrieves, from the learning history storage device 422, messages of other learners which are similar to or associated with the message transmitted from the learner.

The editing device 406 converts the retrieved messages into, for example, a colloquial form.

The message transmitted from the learner contains user ID (the identification information of the learner), material ID (identification information corresponding to a portion of the learning material which is currently learnt by the learner), and the like. When this message is received by the communication device 402, it is further sent to the learning history management device 408.

The learning history management device 408 temporarily stores the message as a learning history in the temporary storage device 410 in correspondence with the user ID of the learner and material ID. The learning history stored in this temporary storage device 410 is sent to the learning history storage device 422 at the end of learning. Learning histories are stored in the learning history storage device 422 for each learner.

The evaluation device 404 evaluates each learner on the basis of the learning histories of each learner, i.e., the contents of messages, the number of messages (the number of times of transmission of messages), the number of times of being referred to by other learners (referring count), information indicating relationships with other learner, and the like which are stored in the learning history storage device 422. An evaluation result for each learner is also considered as the grade of each learner. This evaluation result of each learner (i.e., the grade of each learner) is stored as part of personal information in the personal information storage device 423.

The certified device 407 diagnoses the qualification of a learner as a member of this learning support system (the qualification for the learning community). The certified device 407 performs this diagnosis on the basis of a qualification rule stored in advance in the certified device 407 and the grade of each learner stored in the personal information storage device 423.

The qualification rule is a rule for determining the qualification for the learning community on the basis of the grade stored in the personal information storage device 423.

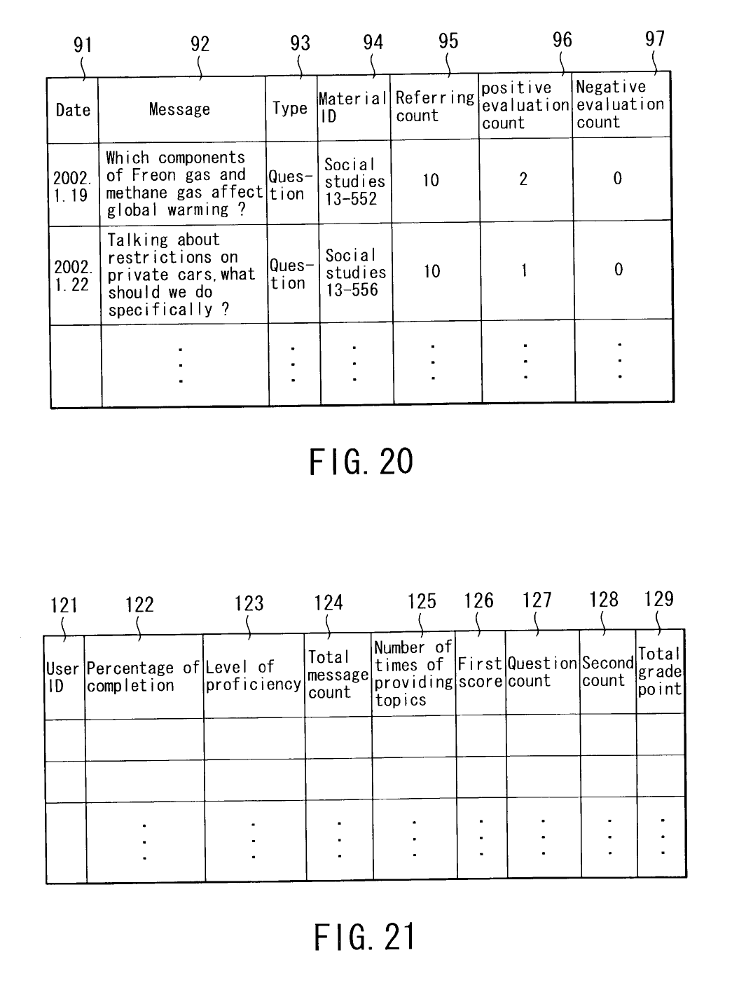

FIG. 20 shows learning histories corresponding to a given learner which are stored in the learning history storage device 422. Note that the learning histories shown in FIG. 20 are only portions other than the learning histories shown in FIG. 3. The learning histories shown in FIG. 20 includes a date 91 when the learner inputs (transmits) a message to the learning support system in the process of learning on the basis of a distributed learning material, the input message 92, a type 93 of the message (a question or a comment (including a sentence aimed at providing a topic), a material ID 94 which is included in the input message, the number of times (referring count) 95 that the message was referred to by other learners after it is registered as a learning history, a positive evaluation count 96, a negative evaluation count 97, and the like.

For example, the positive evaluation count is the number of times that the message was evaluated as effective by other learners, and the negative evaluation count is the number of times that the message was evaluated as useless by other learners.

FIG. 21 shows an example of the data of the above grades (grade data) which is part of the personal information stored in the personal information storage device 423.

Assume that each of a plurality of learners who take part in the learning support system to learn belongs to one learning community (a group of user). Note that a plurality of learning communities may exist. Assume, however, that in this case, only one learning community exists for the sake of descriptive convenience.

Grade data on each learner indicates the degree of progress/level of proficiency of learning and the degree of contribution to the learning community and the like. The grade data includes a user ID 121 of the learner, a percentage of completion 122, a level of proficiency 123, the number of messages transmitted by the learner (total message count 124), the number of comments of the messages transmitted by the learner (the number of times of providing topics 125), a first score 126 corresponding to the point which other learners gave to the comments transmitted by the learner, the number of questions (question count 127) of the messages transmitted by the learner, a second score 128 corresponding to the point which other learners gave to the questions transmitted by the learners, and the sum total (total grade point 129) of first and second scores.

More specifically, the first score is calculated from the referring count 95, positive evaluation count 96, and negative evaluation count 97 with respect to the respective comments of the learning histories of each learner stored in the learning history storage device 422. For example, the weight “5” and weight “2” are determined with respect to the positive evaluation count and negative evaluation count, respectively, and the first score for each comment is calculated by “(referring count)+(positive evaluation count)×5−(negative evaluation count)×2”. The first scores for all the comments transmitted by the learner are added together to obtain the first score 126 of the learner.

The second score is calculated from the referring count 95, positive evaluation count 96, and negative evaluation count 97 with respect to each question comment of the learning histories of each learner stored in the learning history storage device 422. For example, the weight “5” and weight “2” are determined with respect to the positive evaluation count and negative evaluation count, respectively, and the second score for each question is calculated by “(referring count)+(positive evaluation count)×5−(negative evaluation count)×2”. The second scores for all the questions transmitted by the learner are added together to obtain the second score 128 of the learner.

According to this learning support system, it is an object to allow all the learners who intend to learn by using the system to learn efficiently by sharing the questions and comments transmitted by the respective learners. Therefore, learners who make no utterances or learners who transmit only senseless, insignificant messages irrelevant to the messages transmitted from other learners and tend to thwart other learners' attempts to learn rather than contributing to the learning community are excluded from this learning community. For this purpose, the certified device 407 checks by using the first and second scores whether each learner is qualified for the learning community. Any learner who is determined as disqualified by the certified device 407 is excluded from the learning community. That is, the excluded learner cannot learn by using the learning support system shown in FIG. 19.

For example, by periodically checking on the basis of the grade data shown in FIG. 21 whether each learner is qualified for the learning community, and excluding any learner determined as disqualified in this manner, it can be expected that each learner will frequently transmit better, more effective messages in the process of learning. It can therefore be expected that the activity of the learning community will be activated, resulting in an improvement in the learning efficiency of each learner.

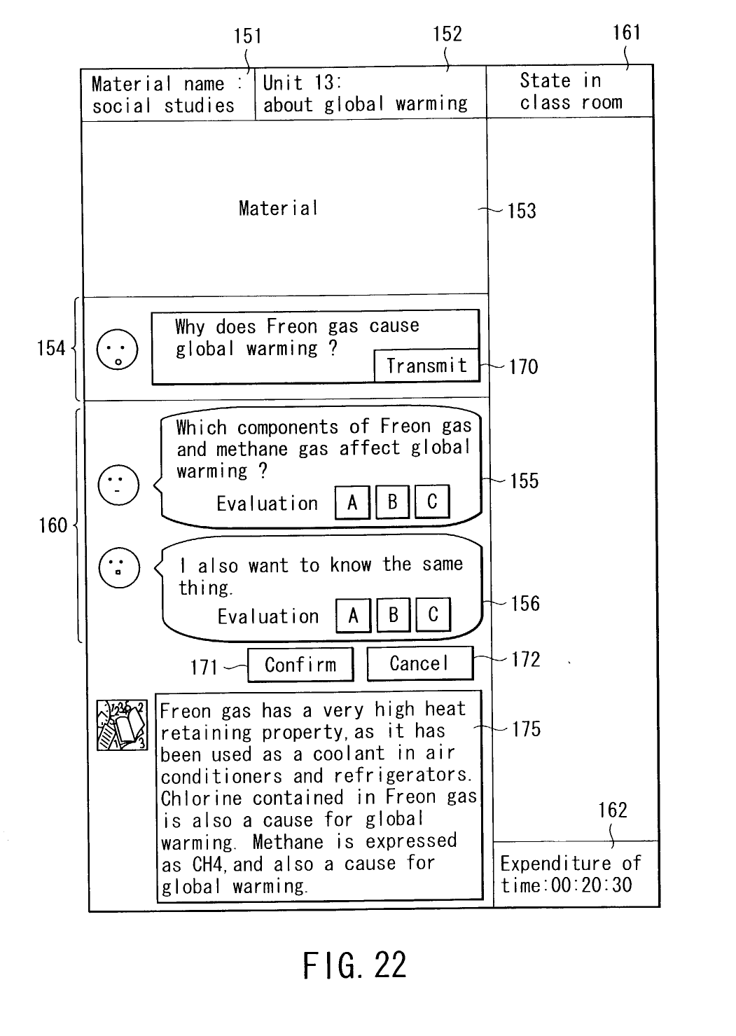

FIG. 22 shows a window example displayed on the display of the learning material output device 2 by the output device 304 when a learner is learning on the basis of the learning material distributed to the terminal apparatus 300.

FIG. 22 shows, in particular, a window example displayed when the learner has input a question in the process of learning.

Referring to FIG. 22, the display screen of the terminal apparatus 300 is comprised of a plurality of areas 151 to 154, 157, 160, 161, and 162.

In the areas 151 and 152, the name of the learning material currently learnt by the learner and information corresponding to the material ID of the learning material such as a unit are displayed.

The learning material is displayed in the area 153. The message input by the learner is displayed in the area 154. In the area 160, utterances from members (other learners) of a pseudo-learning community produced on the basis of messages related to (similar to or associated with) the message input in the area 154 are displayed. In this case, two utterances 155 and 156 are displayed.

An answer to the message input in the area 154 is displayed in the area 157.

In the area 161, the learning histories retrieved by the retrieval device 405 are displayed, for example, in the manner shown in FIG. 8 as in the second embodiment described above.

In the area 162, the expenditure of time measured by the timer 409 is displayed in the area 162 as in the second embodiment described above.

Note that the area 154 is also an input area in which a message is input by the learner. When the learner inputs a message in the area 154 and presses (selects) a “transmit” button 170, the areas 160 and 157 in FIG. 22 are displayed.

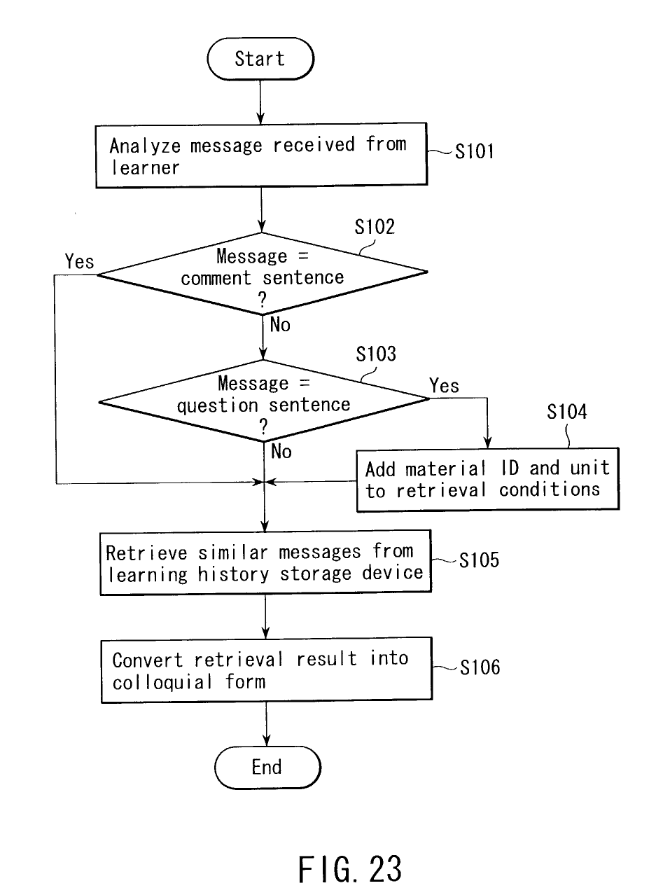

The operation of the learning support system shown in FIG. 18 in a case wherein the learner has input a comment or question will be described next with reference to the flow chart of FIG. 23. Processing for the generation of utterances from the members of the learning community will be mainly described below.

Assume that the learner has input a message in the area 154 in the process of learning on the basis of a distributed learning material, and selected the “transmit” button 170 with a pointing device such as a mouse. In this case, the message input in the area 154 is transmitted as a packet in a predetermined format to the server apparatus 310.

Upon reception of the transmitted packet through the communication device 402 of the server apparatus 310, the analysis device 403 analyzes the message in the packet and checks whether the message is a comment or a question (step S101).

If the message is a comment (step S102), the retrieval device 405 retrieves messages which are similar to or associated with the comment from the messages input by other learners stored in the learning history storage device 422 without limiting any material ID and unit (step S105).

If the message is a question (step S103), the retrieval device 405 retrieves messages which correspond to the same material ID or unit as that added to the question and are similar to or associated with the question from the messages input by other learner stored in the learning history storage device 422 (steps S104 and S105).

If the message transmitted from the terminal apparatus 300 is a question, messages which are similar to or associated with the question are retrieved from the messages which are input when a plurality of learners learnt the same portion of the same learning material and stored in the learning history storage device 422.

The editing device 406 converts the retrieved messages into a colloquial form (step S106). If, for example, the retrieved message is a question, a subject such as “I” is added to the beginning of the sentence. In addition, a question expression like “will you teach me about” may be deleted from the retrieved message and replaced with an expression of consent like “cannot understand” or “want to know”. If the retrieved message is a comment, an expression of consent like “that's it” may be added to the beginning of the sentence. In this manner, the editing device 406 converts retrieved messages from other learners into utterances transmitted from them in accordance with the input message.

If the message transmitted from the learner is a question, the retrieval device 405 retrieves an answer to the question from the storage unit 420.

If the message transmitted from the learner (to be referred to as a received message hereinafter) is a comment, the communication device 402 transmits, under the control of the control device 401, the messages converted into a colloquial form by the editing device 406 in the above manner and the user IDs of the learners who transmitted the messages, to the terminal apparatus 300 of the learner as the source of the received message. If the received message is a question, the communication device 402 transmits the messages converted in a colloquial form by the editing device 406 in the above manner the user IDs of the learners who transmitted the messages, to the terminal apparatus 300 of the learner as the source of the received message, together with an answer to the received message (question).

If the message transmitted from the learner is a comment, the terminal apparatus 300 displays the retrieved messages from other learners as utterances from members of the learning community in the area 160 in FIG. 22. If the message transmitted from the learner is a question, the retrieved messages from other learner are displayed as utterances from members of the learning community in the area 160 in FIG. 22, while an answer to the question is displayed in the area 157 in FIG. 22.

Note that when the retrieved messages from other learners are displayed on the terminal apparatus 300 as shown in FIG. 22, the learner who refers to the messages can input evaluation values with respect to the respective displayed messages.

In this case, for example, three levels “A”, “B”, and “C” are set as evaluation values. Assume that “A” corresponds to “useful”; “C” corresponds to “useless”; and “B” corresponds to “neither”.

The learner selects one of the above evaluation values for each of the displayed messages from other learner on the screen shown in FIG. 22 from his own viewpoint, and then selects the “confirm” button with a mouse or the like. Thereafter, the evaluation values with respect to the messages from other learners to which the learner referred, are transmitted as, for example, a packet in a predetermined format to the learning support system.

In the learning support system, upon reception of the packet containing the evaluation result, the learning history management device 408 updates the referring count 95, positive evaluation count 96, negative evaluation count 97, and the like for each of the corresponding messages of the learning histories shown in FIG. 20 on the basis of the evaluation result.

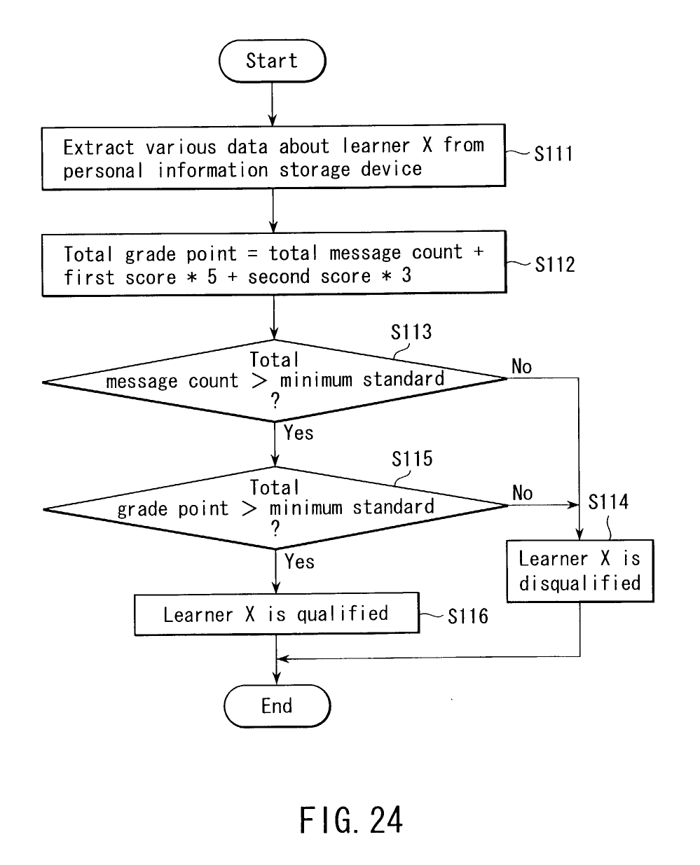

Qualification diagnosis processing in the certified device 407 will be described next with reference to the flow chart of FIG. 24.

The certified device 407 performs qualification diagnosis by referring to the grade data of each learner like that shown in FIG. 21 which is generated on the basis of the learning histories of each learner stored in the learning history storage device 422 (step S111). For example, a total grade point is calculated on the basis of the total message count 124, first score 126, second score 128, and total grade point 129 of the grade data shown in FIG. 21 (step S112). More specifically, by using the total message count, first and second scores, and weights (e.g., “5” and “2”) for the first and second scores, a total grade point is calculated by “total message count+first score×5+second score×3”. Although a method of calculating this total grade point is not specifically limited, a method which at least allows comprehensive evaluation of the total number of messages transmitted from each learner and the contents of each message is preferably used.

In step S113, any learner whose total message count 124 is equal to or less than a predetermined minimum standard is determined as inadequate (disqualified) (step S114).

In step S115, any learner whose total grade point is equal to or less than a predetermined minimum standard is also determined as inadequate (disqualified) even if the total message count 124 is larger than the predetermined minimum standard (step S116).

Only learners who satisfy predetermined standards in terms of the number of messages and the contents and quality of the messages are determined as adequate (qualified) (step S116). That is, only learners having total message counts 124 larger than the predetermined minimum standard and the above total grade points larger than the predetermined minimum standard are determined as qualified.

The learners who are determined as disqualified in step S114 are excluded from the learning community. For example, if messages and questions that are transmitted by learners who are determined as disqualified in step S114, which are stored in the learning history storage device 422, are retrieved in step S105 as described in FIG. 23, the retrieved messages and questions are discarded by the retrieval device 405.

As described above, according to the third embodiment, while the learner X is learning on the terminal apparatus 300 on the basis of a distributed learning material, the server apparatus 310 records the questions and comments input by the learner X as learning histories, together with information indicating the progress of learning (for example the detail of the input operation and the expenditure of time as described in the first and the second embodiment). Learning histories include the user ID of the learner X, a material ID (more specifically, a unit number and the like may be added), and the questions and comments input (transmitted) by the learner X. The learning histories further include a referring count, positive evaluation count, negative evaluation count, and the like concerning these questions and comments.

When the learner X inputs a question or comment in the process of learning, the server apparatus 310 retrieves question or comments similar to or associated with the question or comment input by the learner X from the learning histories recorded when other learners learnt on the basis of the same learning material as that of the learner X in the past. These retrieved questions or comments are then converted into utterances from other learners in accordance with the question or comment input by the learner X and transmitted to the terminal apparatus 300 that corresponds to the learner X.

When the utterances from other learners that are generated in the above manner are displayed on the terminal apparatus 300, the learner X can know in the process of learning at home how other learners react to his utterance or what kinds of questions they have. This gives the learner X the feeling of simultaneously learning together with other students in a class room, and hence improve the learner X's willingness to learn. In addition, opinions and questions from other learners are presented as if they reacted to an utterance from the learner X in real time. This allows the learner X to learn by himself while making the most of the effect of group learning. A learning environment can therefore be provided, which prevents each learner from having a sense of isolation and gives each learner the feeling of actually learning together with a plurality of other learners.

In addition, it is checked on each of a plurality of learners whether the number and quality of question or comments input by each learner during learning satisfy the predetermined minimum standards, and any learners who do not satisfy these minimum standards are excluded from the learning community. And the utterances, which are generated in the above manner and are from other learners who are determined as qualified, are displayed on the terminal apparatus 300. By introducing such a screening system for participation in this learning support system that corresponds to the learning community, it can be expected that the quality of the respective learners will improve and encourage each other to improve the overall level of the learning community.

The techniques according to the first to third embodiments described above (the respective components of the terminal apparatus 10 in FIG. 1, the respective components of the server apparatus 30 in FIG. 17, and the respective components of the server apparatus 310 in FIG. 19, in particular) can be implemented as programs that can be executed by a computer. In addition, such programs can be stored in a recording medium such as a magnetic disk (e.g., a floppy disk or hard disk), an optical disk (e.g., a CD-ROM or DVD), a semiconductor memory, or the like and distributed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A learning support method applied to a learning support system which comprises a server apparatus and a plurality of terminal apparatuses, the terminal apparatuses corresponding to a plurality of users respectively, the server apparatus distributing a learning material to each of the terminal apparatus, each of the users operating one of the terminal apparatuses in order to learn the learning material during the one of the terminal apparatuses accessing the server apparatus, the method comprising:
detecting an input operation by the each of the users, whenever the each of the users operates one of the terminal apparatus;
storing a learning history of the each of the users whenever the input operation is detected, the learning history including at least detail of the input operation and a first time period which is a time period from a starting time when the each of the users starts learning the learning material until when the input operation is detected, to obtain a set of learning histories corresponding to the each of the users and being stored from the starting time until when the each of the users finishes to learn the learning material;
retrieving, whenever a predetermined time period elapses from the starting time corresponding to a first user who is one of the users, at least one learning history, to obtain a retrieved learning history whose the first time period is equal to or nearly equal to a second time period from the starting time corresponding to the first user until when the predetermined time period elapses, from the set of learning histories corresponding to a second user who is another of the users;
displaying at least the retrieved learning history on one of the terminal apparatuses corresponding to the first user.

2. A method according to claim 1, which includes:
storing a plurality of personal information items, each of the personal information items corresponding to the each of the users;
and wherein the retrieving step retrieves the learning history which corresponds to the second user whose personal information item which is one of the personal information items is similar to a first personal information item which is another of the personal information items and corresponds to the first user.

3. A method according to claim 1, wherein the retrieving step retrieves the learning history which corresponds to the second user whose the set of learning histories is similar to the set of learning histories corresponding to the first user.

4. A method according to claim 1, which includes:
editing the retrieved learning history, to obtain edited learning history;
and wherein the displaying step displays the edited learning history.

5. A method according to claim 1, which includes:
evaluating the set of learning histories, to obtain an evaluation result corresponding to the each of the users;
displaying the evaluation result on each of the terminal apparatuses corresponding to the each of the users.

6. A method according to claim 1, wherein the displaying step displays a information item for contact with the second user.

7. A method according to claim 1, which includes:
storing a message corresponding to one of a question and a comment, the message being input by the input operation, whenever the input operation for inputting the message is detected, to obtain stored messages corresponding to the each of the users; and which includes:
retrieving from the stored messages corresponding to one of the users except for the first user, when the first user input the message, at least one of the stored messages which is similar to or relates to the message input by the first user, to obtain retrieved message; and
displaying the retrieved message on the first user's terminal apparatus.

8. A method according to claim 7, which includes:
converting the retrieved message to a response to the message input by the first user; and
displaying the response.

9. A method according to claim 7, which includes:
checking the stored messages corresponding to the each of the users whether the number and the quality of the stored messages satisfy predetermined standards;
determining the each of the users a qualified user when the number and the quality of the input messages satisfy the standards;
and wherein retrieving from the stored messages includes retrieving the one of the messages corresponding to the qualified user.

10. A learning support system which comprises a server apparatus and a plurality of terminal apparatuses, the terminal apparatuses corresponding to a plurality of users respectively, the server apparatus distributes a learning material to each of the terminal apparatus, each of the users operate one of the terminal apparatuses in order to learn the learning material, the system comprising:
a detection device configured to detect an input operation by the each of the users, whenever the each of the users operates one of the terminal apparatus;
a storing device configured to store a learning history of the each of the users whenever the input operation is detected by the detection device, the learning history including at least detail of the input operation and a first time period which is a time period from a starting time when the each of the users starts learning the learning material until when the input operation is detected, to obtain a set of learning histories corresponding to the each of the users and being stored from the starting time until when the each of the users finishes to learn the learning material;
a retrieving device configured to retrieve, whenever a predetermined time period elapses from the starting time corresponding to a first user who is one of the users, at least one learning history, to obtain a retrieved learning history whose the first time period is equal to or nearly equal to a second time period from the starting time corresponding to the first user until when the predetermined time period elapses, from the set of learning histories corresponding to a second user who is another of the users;
a displaying device configures to display at least the retrieved learning history on one of the terminal apparatuses corresponding to the first user.

11. A system according to claim 10, further comprising:
a second storing device configured to store a plurality of personal information items, each of the personal information items corresponding to the each of the users;
and wherein the retrieving device retrieves the learning history which corresponds to the second user whose personal information item which is one of the personal information items is similar to a first personal information item which is another of the personal information items and corresponds to the first user.

12. A system according to claim 10, wherein the retrieving device retrieves the learning history which corresponds to the second user whose the set of the learning histories is similar to the set of learning histories corresponding to the first user.

13. A system according to claim 10, further comprising:
an editing device configured to edit the retrieved learning history, to obtain edited learning history;
and wherein the displaying device displays the edited learning history.

14. A system according to claim 10, further comprising:
an evaluating device configured to evaluate the set of learning histories, to obtain an evaluation result corresponding to the each of the users;
a second displaying device configured to display the evaluation result on each of the terminal apparatuses corresponding to the each of the users.

15. A system according to claim 10, wherein the displaying device displays a information item for contact with the second user.

16. A system according to claim 10, wherein the server apparatus comprising: the detection device, the storing device, the retrieval device, and the displaying device.

17. A system according to claim 10, further comprising:
a second storing device configured to store a message corresponding to one of a question and a comment, the message being input by the input operation, whenever the input operation for inputting the message is detected, to obtain stored messages corresponding to the each of the users; and which includes;
a second retrieving device configured to retrieve from the stored messages corresponding to one of the users except for the first user, when the first user input the message, at least one of the stored messages which is similar to or relates to the message input by the first user, to obtain retrieved message; and
a second displaying device configured to display at least the retrieved message on the first user's terminal apparatus.

18. A system according to claim 17, further comprising:
a converting device configured to convert the retrieved message to a response to the message input by the first user;
and wherein the second displaying device displays the response.

19. A system according to claim 17, further comprising:
a checking device configured to check the stored messages corresponding to the each of the users whether the number and the quality of the stored messages satisfy predetermined standards;
a determining device configured to determine the each of the users a qualified user when the number and the quality of the input messages satisfy the standards;
and wherein the second retrieving device retrieves the one of the messages corresponding to the qualified user.

20. A learning support method in a learning system having a server and a plurality of user terminals, each user terminal receive a learning material from the server when one of user terminal requests to start the learning material; the method comprising:
detecting input operations in each user terminal;
measuring an time data for each input operation in each user terminal;
storing learning data for each user terminal into a memory, each learning data including the detected input operation and its corresponding time data;
receiving a search request from a first user terminal which is one of user terminals;
searching at least some of other user's learning data, by comparing the time data of other user's learning data from the memory; and
supplying the searched other user's learning data to the first user terminal so as to display other user's learning data on the first user terminal.

21. A learning support method in a learning system having a server and a plurality of user terminals, each user terminal receive a learning material from the server when one of user terminal requests to start the learning material and said user terminals including a first user terminal and other user terminals; the method comprising:
detecting input operations in each user terminal;
measuring an time data for each input operation in each user terminal;
storing learning data for each user terminal into a memory, each learning data including the detected input operation and its corresponding time data;
searching at least some of learning data for other user terminals, by comparing the time data of learning data stored for other user terminals from the memory; and
supplying the searched learning data for other terminals to the first user terminal other user's learning data.
